(19) United States
(12) Patent Application Publication
(10) Pub. No.: US 2008/0075084 A1
(43) Pub. Date: Mar. 27, 2008

(54) Selecting routing protocol in network

(76) Inventors: Hyo-Hyun Choi, Seoul (KR); Yong Lee, Seoul (KR); Wook Choi, Hwaseong-si (KR); Yong-Seok Park, Seongnam-si (KR)

Correspondence Address: ROBERT E. BUSHNELL, 1522 K STREET NW, SUITE 300, WASHINGTON, DC, 20005-1202, US

(21) Appl. No.: 11/902,335

(22) Filed: Sep. 20, 2007

(30) Foreign Application Priority Data
Sep. 21, 2006 (KR) 10-2006-0091820

(51) Int. Cl. H04L 12/56

(52) U.S. Cl. 370/392; 370/400; 709/242

(57) ABSTRACT

A network includes a plurality of nodes. Each of the nodes has a plurality of routing protocols installed therein and sets a routing protocol suitable for a requested application type. The node acquires a routing protocol suitable for the application type from a route request message, received from a client, to set a route for the client using the routing protocol. A suitable routing protocol is selected according to an application (service) type, requested by a client, in order to set an optimum route according to the application type in a network, thereby minimizing packet transmission delay and maximizing transmission efficiency.

### CLAIM OF PRIORITY

This application makes reference to, incorporates the same herein, and claims all benefits accruing under 35 U.S.C.§ 119 from an application for METHOD AND APPARATUS OF SELECTING ROUTING PROTOCOL IN NETWORK earlier filed in the Korean Intellectual Property Office on the 21 of Sep. 2006 and there duly assigned Serial No. 10-2006-0091820.

### BACKGROUND OF THE INVENTION

1. Field of the Invention

The present invention relates to selecting a routing protocol in a network. More particularly, the present invention relates to a method of and an apparatus for selecting a routing protocol in a network.

2. Description of the Related Art

These days, in response to the development of network technologies, interests are moving from wired networks to mobile wireless networks.

In components of the wired/wireless networks, nodes having a packet-switching function to select a packet route by applying various routing protocols.

In the routing protocols available for the networks, one routing protocol is generally used for one network.

As a larger number of subscribers are accessing the networks, it is necessary to find a method to apply various routing protocols in one network and to select a routing protocol suitable for a situation, thereby minimizing the load of the network or related cost.

Proposed examples of the method of applying various routing protocols to one network are as follows:

(1) A routing table, according to network state is updated to select a routing protocol, which results in a lower cost, such as power to transmit a routing control message to adjacent nodes.

(2) In an ad hoc network including nodes to which a number of routing protocols are applied, one node collects routing protocol information of a limited number of adjacent nodes to select a routing protocol which is most frequently used, and broadcasts selected routing protocol information to all the nodes of the network.

(3) In a distributed router platform, an optimum route is selected from a plurality of routes that are established by routers according to applied routing protocols.

According to the conventional method of selecting a routing protocol in the networks as mentioned above, a routing protocol is selected merely by considering network situations (e.g., a message transmission cost, a most frequently used routing protocol and an optimum route).

However, as more various types of applications (services) are getting provided via the same network, it becomes inefficient to apply the same routing protocol for various applications.

For example, in a wireless mesh network that provides an application, such as a TELNET, which generates a small size packet, and another application such as a File Transfer Protocol (FTP), which generates a large size packet, it is inefficient to select a route using the same routing protocol for both the packets generated by TELNET and FTP.

Accordingly, it is necessary to devise a method that can set a route by selecting a suitable routing protocol according to an application as well as simultaneously applying suitable routing protocols for a plurality of applications in a single network.

### SUMMARY OF THE INVENTION

It is therefore an object of the present invention to provide a method of and an apparatus for selecting a routing protocol in a network including a plurality of nodes, in which each node can select a suitable routing protocol according to an application (service) type requested by a client.

Another object of the present invention to provide a method of and an apparatus for selecting a routing protocol in a network, which can set a route using a suitable routing protocol according to an application type requested by a client in order to minimize packing transmission delay and enhance transmission efficiency.

According to one aspect of the present invention for realizing the above objects, the present invention provides a method of operating a network, the method including: installing routing protocols in each of a plurality of nodes; setting a routing protocol suitable for a requested application type in each of the plurality of nodes; each node acquiring a routing protocol suitable for the application type from a route request message received from a client, and each node setting a route for the client using the routing protocol.

Each node preferably broadcasts a routing control message including type information of the routing protocol, by which the route is set, to an adjacent node.

An adjacent node preferably acquires the type information from the received routing control message to set the route.

Each node preferably acquires information of the application type by analyzing a header of the route request message.

According to another aspect of the present invention for realizing the above objects, the present invention provides a node in a network including a plurality of nodes, the node including: a plurality of routing processors having different routing protocols installed therein, each of the routing processors having a routing table storing route information, the route information being set based upon a respective routing protocol; and a protocol selector having a protocol selection table from which the routing protocols are suitably selected according to application types, the protocol selector selecting a suitable routing protocol for an application type acquired from a route request message received from a client, and transmitting the route request message to a corresponding one of the routing processors having the suitable routing protocol installed therein to activate the corresponding routing processor.

The node preferably further includes: a routing table manager to establish a system routing table based upon the route information stored in the routing tables of the routing processors and entries specifying type information of the routing tables; and a wireless connector to search the system routing table for a predetermined entry, the predetermined entry including a destination address of a packet received via the network and to rout the packet based upon route information of the searched entry.

The routing table manager, in response to the route information of the routing table being added/updated, preferably collects the added/updated information to add/update the entries of the system routing table.

The protocol selector preferably acquires the application type by either extracting a field value of a protocol field or a destination port address field of a header of the route request message.

The protocol selection table preferably includes a plurality of field values of the destination port address field, application type information for each of the field values and type information of routing protocols according to application types, the type information of the routing protocols being primary, reusable or unusable.

The type information of the routing protocols is preferably set primary, reusable or unusable in the protocol selection table, based upon packet characteristics according to the application type.

The protocol selector preferably acquires destination address information of the route request message and type information of the suitable routing protocol, determines whether or not a first entry identical with the destination address information and the type information of the suitable routing protocol exists in the system routing table; and uses route information of the first entry as route information for the route request message in response to the first entry existing in the system routing table; or searches a second entry identical with the destination address information in response to the first entry not existing in the system routing table, and using the type information of the routing protocol of the second entry as route information for the route request message in response to type information of a routing protocol of the second entry being reusable for the application type.

Each of the routing processors preferably sets route information for the route request message and broadcasts a routing control message specifying type information of an installed routing protocol to an adjacent node. The routing control message is created by specifying the type information of the installed routing protocol in a type field.

The protocol selector preferably transmits a routing control message, received from an adjacent node, to a routing processor having a predetermined routing protocol acquired from the routing control message installed therein.

According to still another aspect of the present invention for realizing the above objects, the present invention provides a node in a network including a plurality of nodes, the node including: a plurality of routing processors having different routing protocols installed therein, each of the routing processors having a routing table storing route information, the route information being set based upon a respective routing protocol; and a protocol selector to acquire type information of the routing protocols of the routing processors and to transmit a routing control message, received from an adjacent node, to a predetermined routing processor having a routing protocol acquired from the routing control message installed therein; a routing table manager to establish a system routing table based upon the route information stored in the routing tables of the routing processors and entries specifying type information of the routing tables; and a wireless connector to search the system routing table for an entry including a destination address of a packet received via the network, and to rout the packet based upon route information of the searched entry.

According to yet another aspect of the present invention for realizing the above objects, the present invention provides a method of selecting a routing protocol in a network, the method including: setting routing protocols according to application types at a node in the network, having different types of routing protocols installed therein; acquiring type information of an application type from a route request message received from a client; selecting type information of a routing protocol suitable for the acquired application type to set a route for the route request message; and broadcasting a routing control message, including the type information of the suitable routing protocol, to an adjacent node.

According to a further aspect of the present invention for realizing the above objects, the present invention provides a method of selecting a routing protocol, carried out by a node in a network, the method including: establishing a route selection table including routing protocols to be selected according to application types; acquiring type information of an application type from a route request message received from a client; activating a routing protocol suitable for the acquired application type, to set a route for the route request message, and storing route information of the set route in a routing table; broadcasting a routing control message, including type information of the suitable routing protocol, to an adjacent node; establishing a system routing table based upon route information set according to the routing protocols and entries specifying type information of the routing protocols; and searching the system routing table for a predetermined entry, including a destination address of a packet received via the network, and routing the packet based upon route information of the searched entry.

Acquiring type information of an application type preferably includes extracting either a protocol field value or a value of a destination port address field of a header of the route request message.

Establishing a system routing table preferably includes using a plurality of field values to be set in a destination port address field of the route request message, application type information for the field values, and type information of routing protocols set to primary, reusable and unusable based upon packet characteristics according to the application type.

The method preferably further includes: acquiring destination address information of the route request message and the type information of the routing protocol suitable for the application type; determining whether or not a first entry identical with the destination address information and the type information of the suitable routing protocol exists in the system routing table; using route information of the first entry as route information for the route request message in response to the first entry existing in the system routing table; searching a second entry identical with the destination address information in response to the first entry not existing in the system routing table; and using the type information of the routing protocol of the second entry as route information for the route request message in response to type information of a routing protocol of the second entry being reusable for the application type.

Broadcasting a routing control message preferably includes specifying the type information of the routing protocol, by which the route is set, in a type field of the routing control message.

Establishing a system routing table preferably includes: collecting added/updated route information to add/update the entries of the system routing table in response to route information of the routing tables being added/updated.

According to yet another aspect of the present invention for realizing the above objects, the present invention provides a method of selecting a routing protocol, carried out by a node in a network, the method including: installing plural types of routing protocols; acquiring type information a routing protocol from a routing control message received from an adjacent network; activating the acquired routing protocol to set a route for the routing control message and storing route information of the set route in a routing table; broadcasting a control message, including the type information of the routing protocol for the set route, to an adjacent node; establishing a system routing table based upon route information, set according to the routing protocols and entries specifying type information of the routing protocols; and searching the system routing table for a predetermined entry, including a destination address of a packet received via the network, and routing the packet based upon route information of the searched entry.

### BRIEF DESCRIPTION OF THE DRAWINGS

A more complete appreciation of the present invention, any many of the attendant advantages thereof, will become readily apparent as the present invention becomes better understood by reference to the following detailed description when considered in conjunction with the accompanying drawings in which like reference symbols indicate the same or similar components, wherein:

FIG. 1 is a conceptual view of a wireless mesh network according to an embodiment of the present invention;

FIG. 2 is an internal block diagram of a node according to an exemplary embodiment of the present invention;

FIG. 3 is a table of the header of a packet to which the present invention is applied;

FIG. 4 is a view of a protocol selection table according to an exemplary embodiment of the present invention;

FIG. 5 is a view of a system routing table according to an exemplary embodiment of the present invention;

FIGS. 6A to 6D are views of a routing control message according to the present invention;

FIGS. 7A and 7B are a conceptual view of a route setting process by a node according to the present invention;

FIG. 8 is a flowchart of a method of selecting a routing protocol according to an exemplary embodiment of the present invention;

FIG. 9 is a flowchart of a method of selecting multiple routing protocols in a network, carried out by an initial node, according to an exemplary embodiment of the present invention; and

FIG. 10 is a flowchart of a method of selecting multiple routing protocols in a network, carried out by an intermediate node, according to an exemplary embodiment of the present invention.

### DETAILED DESCRIPTION OF THE INVENTION

Hereinafter a method of and an apparatus for selecting multiple routing protocols of the present invention are described with reference to the accompanying drawings, in which a wireless mesh network is illustrated. However, it should be understood that the following detailed description will apply equally to other wired/wireless networks.

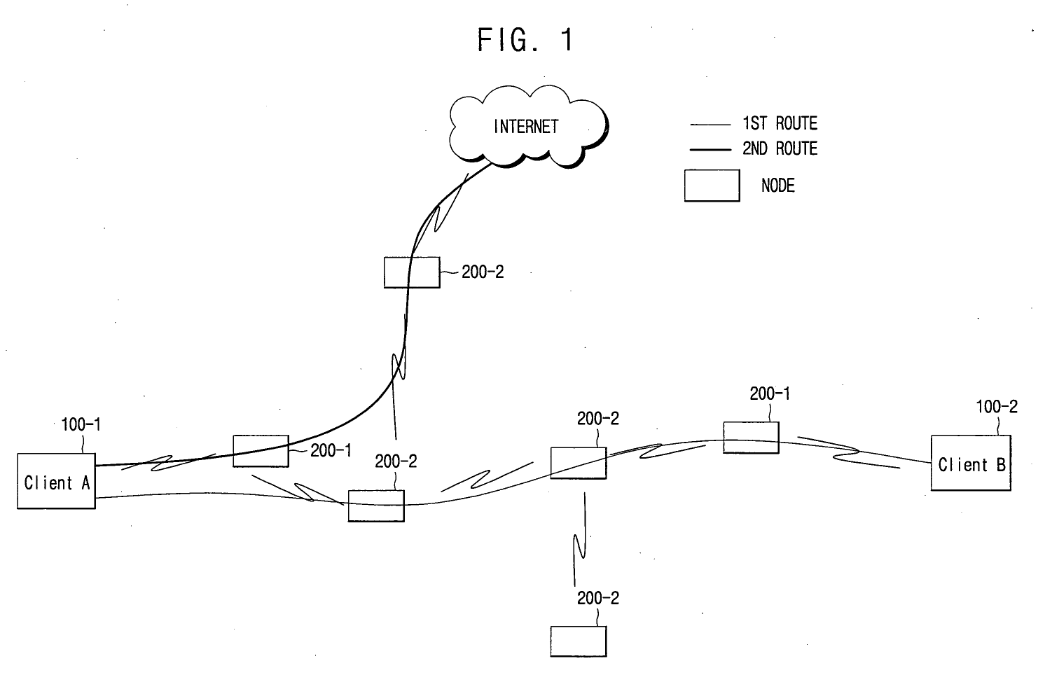

FIG. 1 is a conceptual view of a wireless mesh network according to an embodiment of the present invention.

As shown in FIG. 1, the wireless mesh network includes a plurality of (mesh) nodes 200 (or 200-1 and 200-2) and clients 100 (or 100-1 and 100-2). In a wireless mesh network, the nodes 200 are wirelessly connected, and each of the clients 100, which a user wirelessly accesses, is also wirelessly connected to an adjacent one of the nodes 200.

The client A 100-1 is connected to the client B 100-2 via a first route and to the Internet via a second route.

The first and second routes, through which the client A 100-1 is connected to the client B 100-2 and to the Internet, can be changed according to routing protocols used by the nodes 200 on the first and second routes.

That is, a respective node 200, which has a plurality of routing protocols installed therein, can acquire application (service) type information of the clients 100 to select a routing protocol adequate for the application type of the clients 100, thereby setting a suitable route.

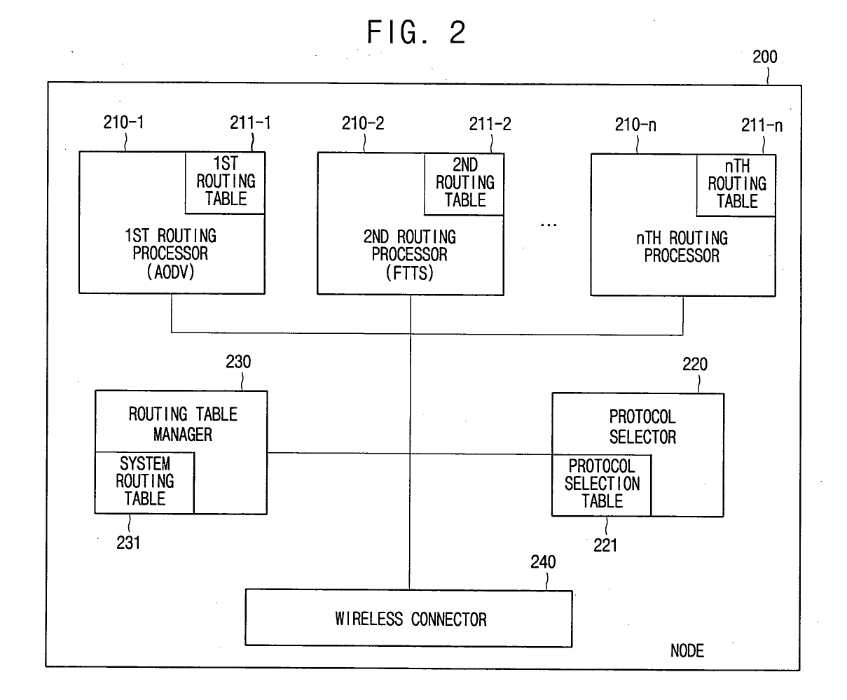

FIG. 2 is an internal block diagram of nodes according to an exemplary embodiment of the present invention.

Referring to FIG. 2, a node 200 of the present invention includes a wireless connector 240, a plurality of routing processors 210 (or 210-1 to 210-n), a protocol selector 220 and a routing table manager 230. The routing table manager 230 includes a system routing table 231 and the protocol selector 230 includes a protocol selection table 221.

The routing processors 210-1 to 210-n can be implemented with software (e.g., programs) installed in hardware (e.g., a board or a chip), or with individual hardware units.

The routing table 211, the protocol selection table 221 and the system routing table 231 can be realized as a register, in the routing processors 210-1 to 210-n, the protocol selector 220 and the routing table manager 230, or stored in a separate storage area.

Different routing protocols are installed in the routing processors 210-1 to 210-n so that the individual routing processors 210-1 to 210-n can operate using the installed routing protocol to select a route to send a packet.

Examples of the routing protocol, installed in the routing processors 210-1 to 210-n, may include various types of routing protocols used in wireless networks, such as Destination Sequenced Distance Vector (DSDV), Dynamic Source Routing (DSR), Ad hoc On-demand Distance Vector (AODV) and Zone Routing Protocol (ZRP).

In the following detailed description of the present invention, it will be assumed that AODV, effective to route a relatively smaller packet, is installed in the first routing processor 210-1, and Fastest Transmission Time Selection (FTTS), effective to route a relatively larger packet, is installed in the second routing processor 210-2.

AODV, which is one of protocols widely known in the ad hoc network field, starts broadcasting a routing control message only in response to a route-setting request. FTTS is a variation of AODV.

Briefly describing the difference between AODV and FTTS, the routing metric of AODV is a hop number, but the routing metric of FTTS is a transmission time, defined as the reciprocal of the transmission rate.

In the case of AODV, an overlapping route request message is always discarded. In FTTS, the routing table 211 is updated when a route request message having a better routing metric is received.

FTTS is similar to the radio-metric ADOV specified in “IEEE 802.11s.”

When a respective routing processor 210 receives a route request message from the client 100 or a routing control message from an adjacent node 200, it selects a route according to the routing protocol and adds/updates corresponding route information to/in the routing table 211.

When the route information is added/updated to/in the routing table 211, the respective routing processor 210 broadcasts a routing-control message to adjacent nodes 200.

When the route information of the routing table 211, established by the respective routing processor 210, is added/updated, the routing table manager 230 adds/updates the route information to/in the system routing table 231.

That is, the routing table manager 230 collects the route information, which is stored in the routing tables 211 of the routing processors 210, and stores the collected route information in the system routing table 231.

The routing table manager 230 manages the system routing table 231 so that all of the route information stored in the respective routing tables becomes identical with the route information of the system routing table 231.

The protocol selector 220 acquires the types of routing protocols, installed in the respective routing processors 210, and when a route request message is received from the client 100, extracts application type information from the route request message and selects a protocol with reference to the protocol selection table 221.

The protocol selector 220 can store identification information of the respective routing processors 210 and type information of the routing protocols of the routing processors 210.

The protocol selector 220 can also extract the application type information from the header of a TCP/IP packet that is the route request message received from the client 100.

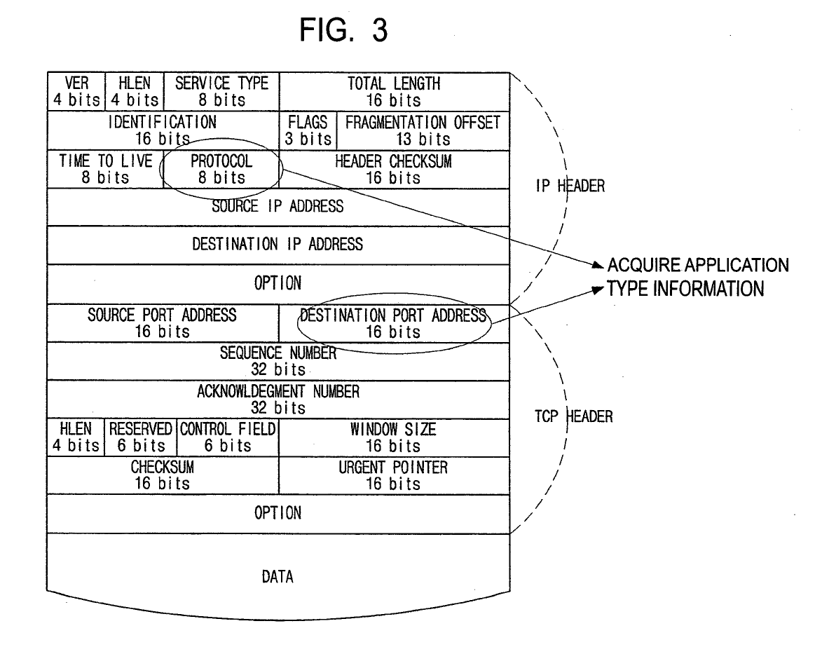

FIG. 3 is a table of the header of a packet to which the present invention is applied.

As shown in FIG. 3, the packet header can be mainly divided into an IP header and a TCP header, each of which includes a plurality of header fields defined in the Internet communication protocol.

In the following, a detailed description of the fields of the IP header and the TCP header has not been included since they are already defined in the communication protocol.

The protocol selector 220 can acquire the application type information, requested by the client 100, by extracting protocol field values or destination port address field values of the TCP header from the IP header of the packet that is the route request message.

The protocol selector 220 selects a routing protocol, suitable for the acquired application type information, from the protocol selection table 221.

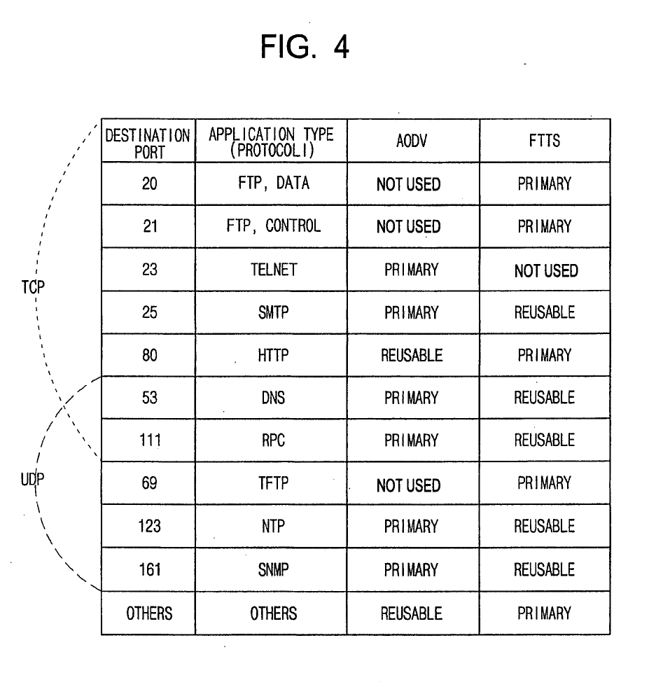

FIG. 4 is a view of a protocol selection table according to an exemplary embodiment of the present invention.

As shown in FIG. 4, the protocol selection table 221 has various information listed therein, such as port values set to destination port address fields, application type information corresponding to the respective port values and routing protocol information adequate to corresponding protocols.

For example, the protocol selector 220 selects “FTP” as the application type information when the port value of the destination address field is “21,” and “FTTS” as a suitable routing protocol when the application type information is “FTP.”

The protocol selector 220 selects “TELNET” as the application type information when the port value of the destination address field is “23,” and AODV” as a suitable routing protocol when the application type information is “TELNET.”

The protocol selection table 221 can be constructed by a manager or a manufacturer of the nodes 200, so, that at least one routing protocol can be selected according to the features of packets (e.g., size and transmission interval), which are generated according to application types.

As illustrated in FIG. 4, if application types are “FTP” and “TELNET,” there no similarities in packets and thus one of the routing protocols such as “AODV” and “FTTS” is set primary. In the case of “SMTP,” since “AODV” is most suitable as a routing protocol and “FTTP” is also reusable or available, “AODV” is set primary and “FTTP” is set reusable.

For example, if the application type information of a route request message, received from the client 100, is “TELNET,” the protocol selector 220 transmits the route request message to the first routing processor 210-1 to activate the first routing processor 210-1. If the application type information is “FTTP,” the protocol selector 220 transmits the route request message to the second routing processor 210-2 to activate the second routing processor 210-2. If the application type information of route request messages is “TELNET” and “FTTP,” the protocol selector 220 transmits the route request messages to the first routing processor 210-1 and the second routing processor 210-2, respectively, to activate the first and second routing processors 210-1 and 210-2.

The routing table manager 230 establishes the system routing table 231 by collecting the type information of the routing tables of the routing processors 210.

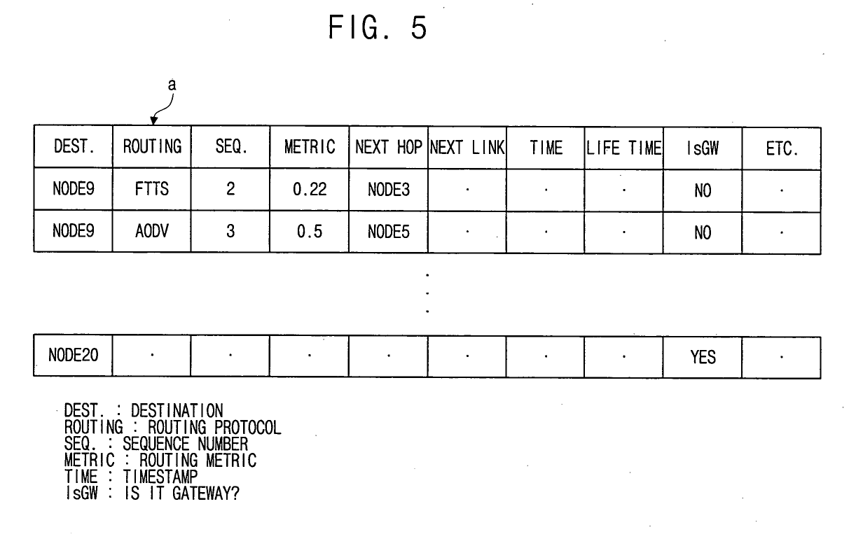

FIG. 5 is a view of a system routing table according to an exemplary embodiment of the present invention.

As shown in FIG. 5, the routing table manager 230 collects the routing tables of the routing processors 210 to establish the system routing table 231, in which the routing protocol types (indicated by “a” in FIG. 5) of the routing processors 210 are specified in entries of the routing tables 211 of the routing processors 210.

That is, the routing table manager 230 establishes the system routing table 231 by collecting the entries including routing information of the routing tables 211, such as destination, sequence, metric and next hop, and specifying the routing protocol types of the corresponding routing protocols 210.

When the routing information of a respective routing table 211 is added/updated, the routing table manager 230 adds/updates the routing information of the system routing table 231.

The nodes 200 of the wireless mesh network can be divided into an initial node that receives a route request message from the client 100 and an intermediate node that receives a routing control message from adjacent nodes (including the initial node).

That is, the protocol selector 220 acquires application type information of a route request message, received from the client 100, in order to select a routing protocol. In response to a routing control message received from an adjacent node 200, the protocol selector 220 acquires type information of a routing protocol from the routing control message and selects a routing protocol in order to determine a routing processor 210 to activate.

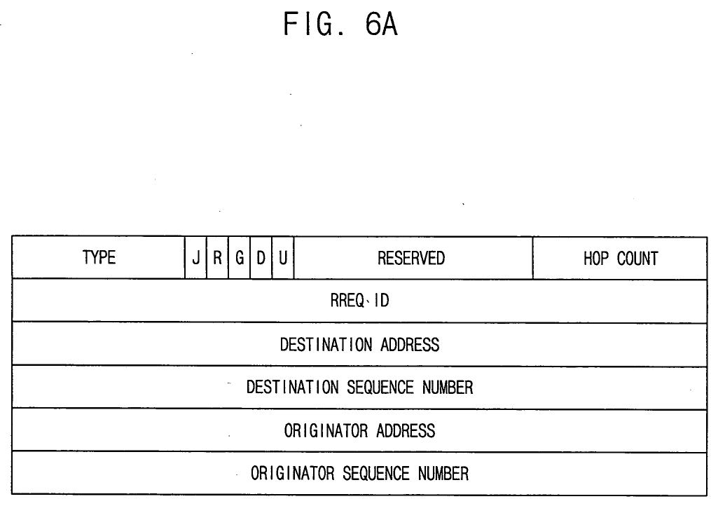

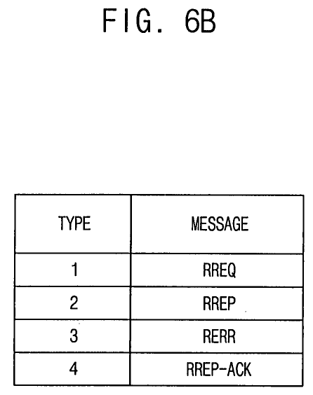

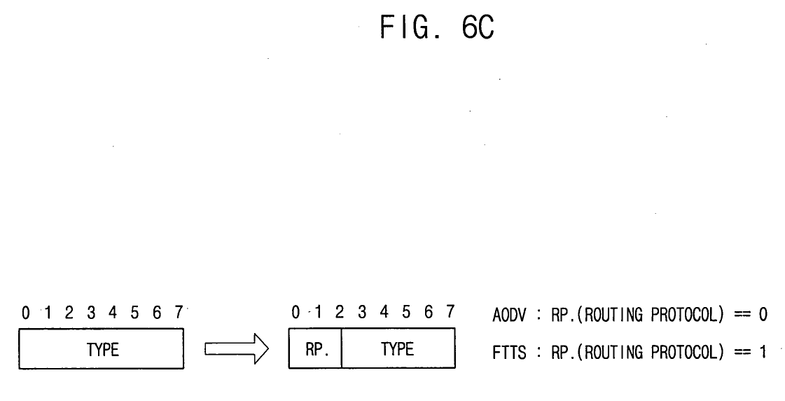

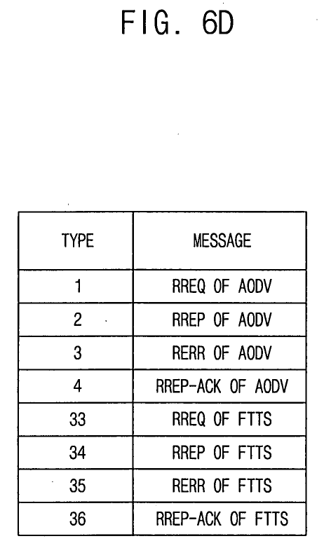

FIGS. 6A to 6D are view of a routing control message according to an embodiment of the present invention.

The routing control message shown in FIG. 6A illustrates an example of a routing control message format according to AODV, and FIG. 6B specifies message types according to type field values.

Field values to be set into type fields are determined according to the type of routing control message shown in FIG. 6A, and message types can be specified in type fields as shown in FIG. 6B. A type field value “1” indicates a routing control message “RREQ,” a type field value “2” indicates a route reply message “RREP,” a type field value “3” indicates a route error message “RERR,” and a type field value “4” indicates a route reply acknowledgment message “RREP-ACK” in response to the route reply message.

In the present invention, since one node 200 can simultaneously activate a plurality of routing protocols, it is necessary that routing control messages to be broadcast to adjacent nodes 200 can be classified according to routing protocols.

FIG. 6C illustrates a type field according to an embodiment of the present invention. The type information of a routing protocol can be specified, as shown in FIG. 6C, by dividing an eight (8) bit type field into a two bit routing protocol type field RP and a six bit type field.

As illustrated, the node 200 can set “0” in the type field “RP” of a routing protocol, in which route information is set, if the routing protocol is AODV but “1” in the type field RP of the routing protocol if the routing protocol is FTTP. Then, the node 200 can set a message type in the 6 bit type field and broadcast the routing protocol to the adjacent nodes 200.

The node 200 can define a type field value specifying the message type according to a routing protocol type in order to broadcast a routing control message to the adjacent nodes 200.

FIG. 6D is a table of field values of type fields according to an embodiment of the present invention. As shown in FIG. 6D, it is possible to define field values corresponding to message types according to routing protocol types.

When the protocol selector 220 of an intermediate node 200 receives a routing control message from an adjacent node 200, it acquires type information of a routing protocol from the routing control message and selects a routing processor 210, where the corresponding routing protocol is installed.

The protocol selector 220 transmits the received routing control message to the selected routing processor 210, so that the selected routing processor 210 can set a route.

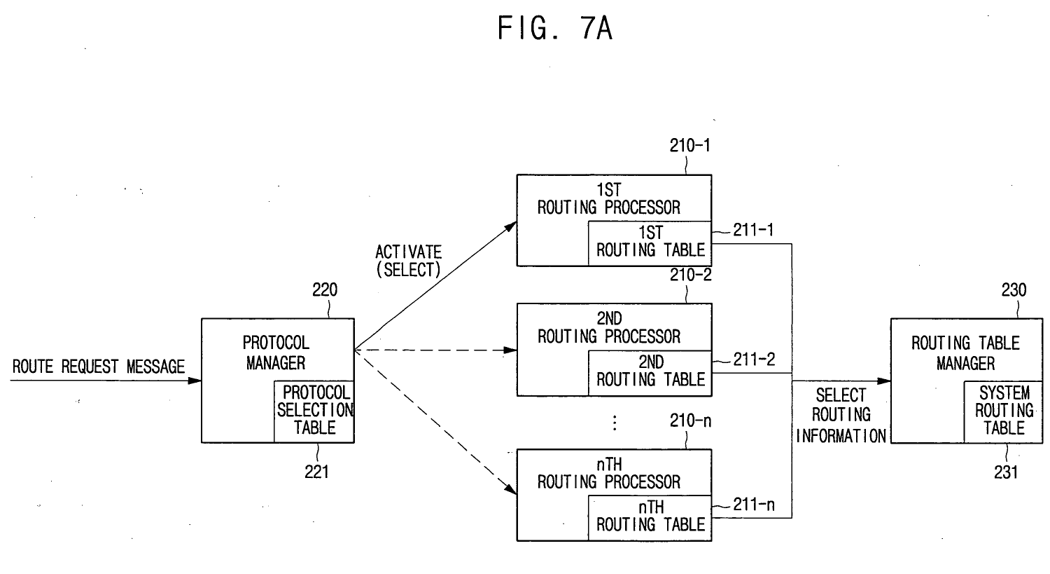

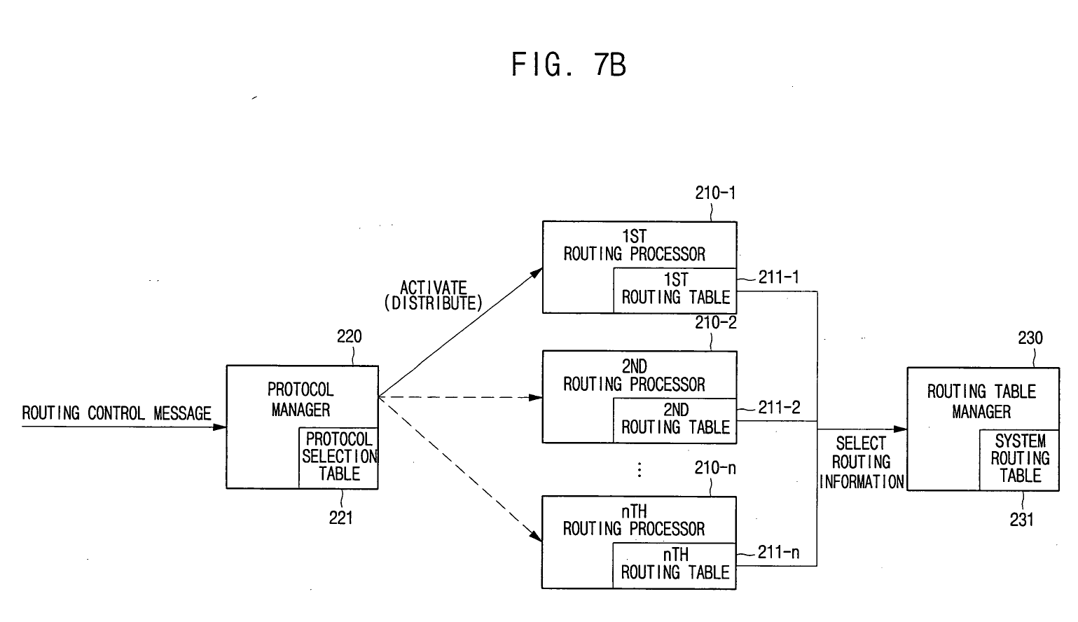

FIGS. 7A and 7B are a conceptual view of a route setting process by a node according to an embodiment of the present invention.

FIG. 7A illustrates a route setting process carried out by an initial node 200. Referring to FIG. 7A, the protocol selector 220 receives a route request message from the client 100.

Then, the protocol selector 220 acquires application type information, requested from the route request message, and selects a suitable routing protocol from the protocol selection table 221.

The protocol selector 220 identifies the routing processor 210, where the selected routing protocol is installed, and activates the selected routing protocol.

If a plurality of route request messages are received, the protocol selector 220 can separately select routing protocols according to application type information of the received route request messages, and transmit the route request messages to corresponding routing processors 210 to simultaneously activate the routing processors 210.

The routing processor 210 sets a route according to the routing protocol and adds/updates routing information to/in the routing table.

When the routing information or the entry of the routing table 211 is added/updated, the routing table manager 230 explicitly adds/updates the type of the routing protocol of the added/updated entry to/in the system routing table 231.

Then, the routing processor 210 broadcasts a routing control message, including the type information of the routing protocol, to an adjacent node 200.

FIG. 7B illustrates a route setting process carried out by an intermediate node 200. Referring to FIG. 7B, when a routing control message is received from an adjacent node 200, the protocol selector 220 acquires type information of a routing protocol from the received routing control message.

Then, the protocol selector 220 transmits the routing control message to a routing processor 210, in which the routing protocol having the acquired type information is installed, to activate the routing protocol.

If a plurality of routing control messages are received, the protocol selector 220 can transmit the routing request messages to corresponding routing processors 210 based upon the type information of routing protocols, which is acquired by the routing control messages, and thus simultaneously activate the routing processors 210.

When the routing control message is received, the routing processor 210 sets a route using the routing protocol and adds/updates route information to/in the routing table 211.

When the routing information or the entry of the routing table 211 is added/updated, the routing table manager 230 explicitly adds/updates the type of the routing protocol of the added/updated entry to/in the system routing table 231.

Then, the routing processor 210 broadcasts a routing control message, including the type information of the routing protocol, to another adjacent node 200.

When a route request message is received from the client 100, the protocol selector 220 selects a routing protocol based upon application type information and discerns whether or not an entry having the same destination address exists in the system routing table 231.

If the entry having the same destination address exists in the system routing table 231, the protocol selector 220 identifies the routing protocol type information of this entry. If the routing protocol type information of this entry is identical with the type information of the selected routing protocol, the protocol selector 220 transmits the route request message to the routing processor 210 to use the route information stored in the system routing table 231 without repeating a routing process.

If the destination addresses are the same but the type information of the routing protocols is not identical, the protocol selector 220 refers to the protocol selection table 221 to discern whether or not the type information of the routing protocol of the entry, searched from the system routing table 231, is reusable for the corresponding application type information.

As illustrated in FIG. 4 above, in the protocol selection table 221, routing protocols can be separately set “Primary,” “Reusable” and “Not Used” (unusable) based upon packet features according to application type information. Accordingly, the protocol selector 220 discerns whether or not the type information of routing protocols of an entry, searched from the system routing table 231, is reusable for corresponding application type information.

If the type information of the routing protocols of the entry, searched from the system routing table 231, is reusable, the protocol selector 220 uses route information stored in the system routing table 231.

When the wireless connector 240 receives a route request message from the client 100 or a routing control message from an adjacent node 200, it transmits the received message to the protocol selector 220.

Then, when the wireless connector 240 receives a packet, it searches the system routing table 231 for an entry according to the destination address of the packet and routes the packet according to the entry.

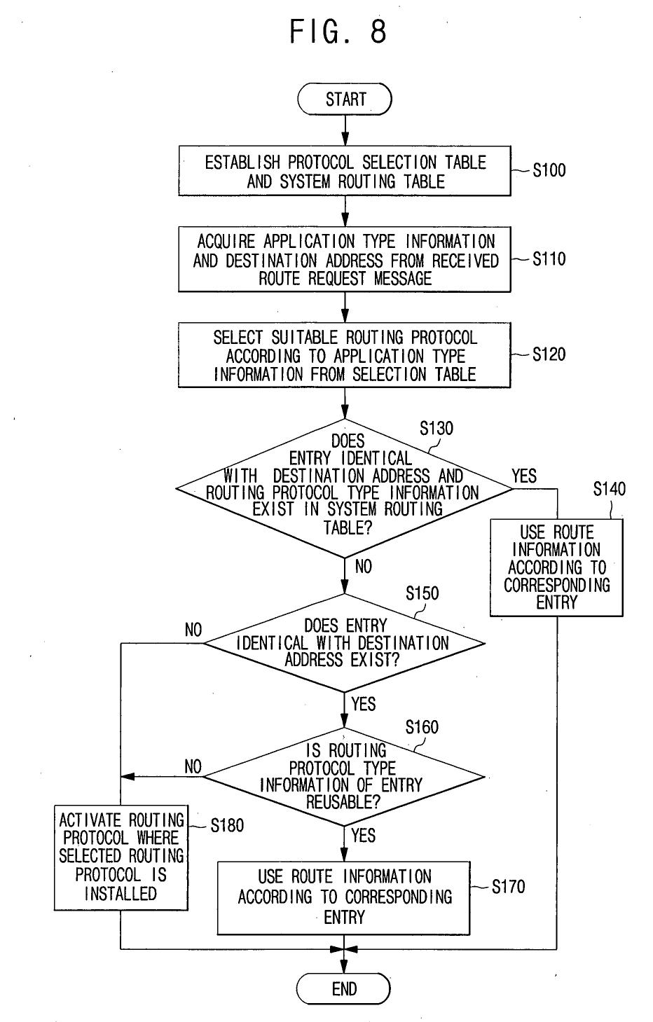

FIG. 8 is a flowchart of a method of selecting a routing protocol according to an exemplary embodiment of the present invention.

Referring to FIG. 8, in S100, respective nodes 200 of the wireless mesh network establish a protocol selection table 221 and a system routing table 231. In the protocol selection table 221, type information of a suitable routing protocol is set according to application type information. The system routing table 231 is constructed of an entry having route information, which is set according to respective routing protocols.

In the protocol selection table 221, the routing protocol can be divided into “Primary,” “Reusable” and “Not Used” (unusable) types based upon packet characteristics according to application type information.

In S110, each node 200 acquires application type information and destination address information from a route request message that is received from the client 100. The node 200 can acquire application type information by extracting a protocol field value or a destination port address field value of a TCP header from an IP header of the route request message.

In S120, the node 200 selects a suitable routing protocol, based upon the acquired application type information, from the protocol selection table 221.

In S130, the node 200 discerns whether or not the system routing table 231 has an entry that is identical with the destination address of the route request message and the type information of the selected routing protocol.

If the system routing table 231 has the entry that is identical with the destination address of the route request message and the type information of the selected routing protocol, the node 200 uses the route information according to this entry in S140.

If the system routing table 231 does not have the entry that is identical with the destination address of the route request message and the type information of the selected routing protocol, the node 200 discerns whether nor there is an entry that is identical only with the destination address in S150.

In S160, if there is the entry that is identical only with the destination address, the node 200 identifies the type information of the routing protocol of this entry and discerns whether or not the type information of the routing protocol of this entry is reusable for the application type information, acquired from the route request message.

If the type information of the routing protocol of this entry is reusable for the application type information, the node 200 uses the type information according to this entry in S170.

If the type information of the routing protocol of this entry is not reusable for the application type information, the node 200 transmits the route request message to a routing processor 210, in which a routing protocol selected from the protocol selection table 221 is installed, to activate the routing processor 210 in S180.

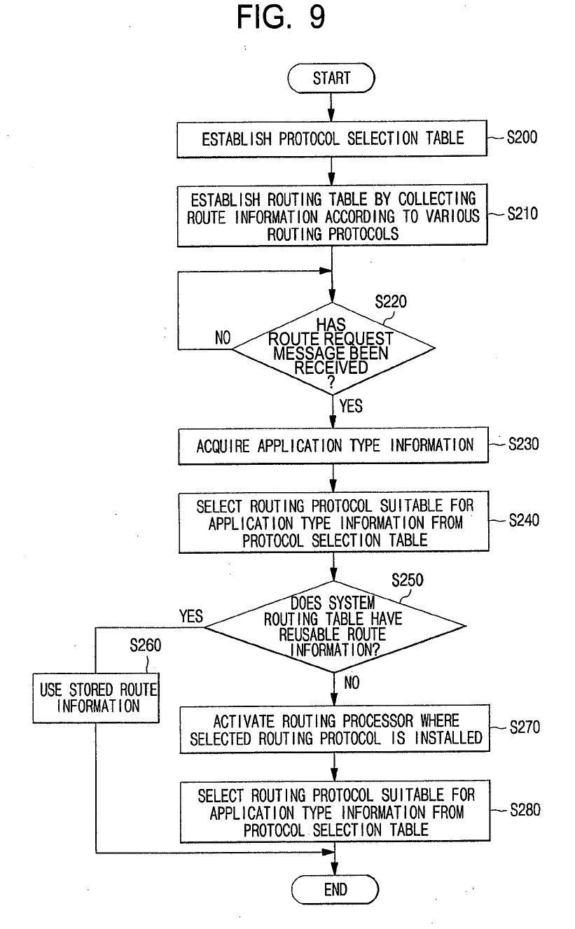

FIG. 9 is a flowchart of a method of selecting multiple routing protocols in a network, carried out by an initial node, according to an exemplary embodiment of the present invention.

Referring to FIG. 9, in S200, respective nodes 200 of the network establish a protocol selection table 221, which will be used to set a suitable routing protocol according to an application type, which is requested from the client 100.

In the protocol selection table 221, the routing protocol can be divided into “Primary,” “Reusable” and “Not Used” types based upon packet characteristics according to the application type.

In S210, each node 200 collects route information, which is set according to a plurality of routing protocols, and establishes a system routing table 231 based upon the route information.

The node 200 establishes the system routing table 231 by generating an entry, which specifies type information of the corresponding routing protocols in the route information created by the routing protocols.

In S220, the node 200 discerns whether or not a route request message has been received from the client 100.

When the route request message has been received, the node 200 analyzes a header area of the route request message to acquire application type information thereof in S230.

In S240, the node 200 selects a routing protocol, suitable for the application type information, from the protocol selection table 221.

Then, the node 200 discerns whether or not route information, stored in the system routing table 231 has reusable route information in S250, and if there is the reusable route information, uses the corresponding route information in S260.

As an example, if an entry is identical with a destination address included in the route request message and type information of the selected routing protocol, or is identical with destination address information and includes type information of a routing protocol reusable for the application type information, the node 200 uses type information of this entry.

If the stored route information does not have reusable route information, the node 200 transmits the route request message to the routing processor 210, where the selected routing protocol is installed, to activate the routing processor 210 in S270.

In S280, the node 200 adds/updates route information, which is set by the activated routing processor 210 according to the routing protocol, to/in the system routing table 231 and broadcasts a routing control message to an adjacent node 200.

The node 200 transmits the type information of the routing protocol on the routing control message to the adjacent node 200 as mentioned above with reference to FIGS. 6A to 6D.

When a plurality of route request messages are received from a plurality of clients 100 or a single client 100, an initial node 200 such as that mentioned above can select routing protocols, suitable for application type information of the respective route request messages, and simultaneously activate corresponding routing processors 210.

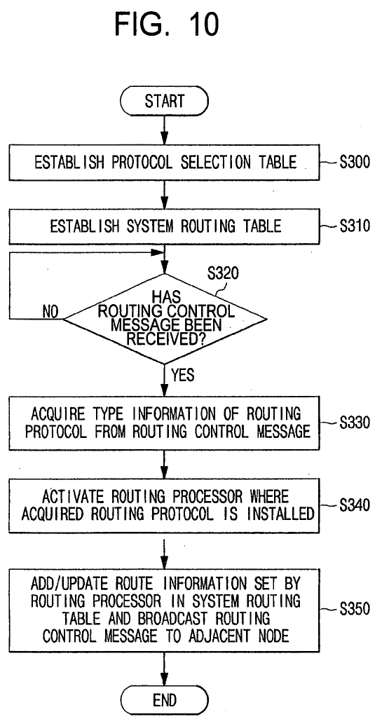

FIG. 10 is a flowchart of a method of selecting multiple routing protocol in a network, carried out by an intermediate node, according to an exemplary embodiment of the present invention.

Referring to FIG. 10, in S300, respective nodes 200 of the network establish a protocol selection table 221, which will be used to set a suitable routing protocol according to an application type, which is requested from the client 100.

In the protocol selection table 221, the routing protocol can be divided into “Primary,” “Reusable” and “Not Used” types based upon packet characteristics according to the application type.

In S310, each node 200 collects route information, which is set according to a plurality of routing protocols, and establishes a system routing table 231 based upon the route information.

The node 200 establishes the system routing table 231 by generating an entry, which specifies type information of the corresponding routing protocols in the route information created by the routing protocols.

The node 200 discerns whether or not a routing control message has been received from an adjacent node 200 in S320.

In S330, the node 200 acquires type information of a routing protocol from the received routing control message.

In S340, the node 200 transmits the routing control message to a routing processor 210, in which a routing protocol of the acquired type is installed, to activate the routing processor 210.

Then, in S350, the node 200 adds/updates route information, which is set by the activated routing processor 210 according to the routing protocol, to/in the system routing table 231, and broadcasts the routing control message to adjacent nodes 200.

When a plurality of routing control messages are received from one or more adjacent nodes 200, an intermediate node 200, such as that mentioned above, can simultaneously activate the routing processors 210 based upon type information of routing protocols, included in the respective routing control messages.

As set forth above, the present invention makes it possible to select a suitable routing protocol according to an application (service) type, which is requested from a client, in order to set an optimum route according to the application type in a network, thereby minimizing packet transmission delay and maximizing transmission efficiency.

Furthermore, when a new application is added to the network, it is also possible to select a routing protocol suitable for the new application.

Moreover, even if a plurality of route requests are received from a client, a plurality of routing protocols can be simultaneously activated to afford routes according to application types.

While the present invention has been shown and described in connection with exemplary embodiments, it will be apparent to those skilled in the art that modifications and variations can be made without departing from the spirit and scope of the present invention as defined by the appended claims.

What is claimed is:

1. A method of operating a network, the method comprising:
installing routing protocols in each of a plurality of nodes;
setting a routing protocol suitable for a requested application type in each of the plurality of nodes;
each node acquiring a routing protocol suitable for the application type from a route request message received from a client, and
each node setting a route for the client using the routing protocol.

2. The method of operating a network according to claim 1, wherein each node broadcasts a routing control message including type information of the routing protocol, by which the route is set, to an adjacent node.

3. The method of operating a network according to claim 1, wherein an adjacent node acquires the type information from the received routing control message to set the route.

4. The method of operating a network according to claim 1, wherein each node acquires information of the application type by analyzing a header of the route request message.

5. A node in a network including a plurality of nodes, the node comprising:
a plurality of routing processors having different routing protocols installed therein, each of the routing processors having a routing table storing route information, the route information being set based upon a respective routing protocol; and
a protocol selector having a protocol selection table from which the routing protocols are suitably selected according to application types, the protocol selector selecting a suitable routing protocol for an application type acquired from a route request message received from a client, and transmitting the route request message to a corresponding one of the routing processors having the suitable routing protocol installed therein to activate the corresponding routing processor.

6. The node according to claim 5, further comprising:
a routing table manager to establish a system routing table based upon the route information stored in the routing tables of the routing processors and entries specifying type information of the routing tables; and
a wireless connector to search the system routing table for a predetermined entry, the predetermined entry including a destination address of a packet received via the network and to rout the packet based upon route information of the searched entry.

7. The node according to claim 6, wherein the routing table manager, in response to the route information of the routing table being added/updated, collecting the added/updated information to add/update the entries of the system routing table.

8. The node according to claim 5, wherein the protocol selector acquires the application type by either extracting a field value of a protocol field or a destination port address field of a header of the route request message.

9. The node according to claim 5, wherein the protocol selection table includes a plurality of field values of the destination port address field, application type information for each of the field values and type information of routing protocols according to application types, the type information of the routing protocols being primary, reusable or unusable.

10. The node according to claim 8, wherein the protocol selection table includes a plurality of field values of the destination port address field, application type information for each of the field values and type information of routing protocols according to application types, the type information of the routing protocols being primary, reusable or unusable.

11. The node according to claim 9, wherein the type information of the routing protocols is set primary, reusable or unusable in the protocol selection table, based upon packet characteristics according to the application type.

12. The node according to claim 10, wherein the type information of the routing protocols is set primary, reusable or unusable in the protocol selection table, based upon packet characteristics according to the application type.

13. The node according to claim 5, wherein the protocol selector acquires destination address information of the route request message and type information of the suitable routing protocol, determines whether or not a first entry identical with the destination address information and the type information of the suitable routing protocol exists in the system routing table; and
uses route information of the first entry as route information for the route request message in response to the first entry existing in the system routing table; or
searches a second entry identical with the destination address information in response to the first entry not existing in the system routing table, and using the type information of the routing protocol of the second entry as route information for the route request message in response to type information of a routing protocol of the second entry being reusable for the application type.

14. The node according to claim 5, wherein each of the routing processors sets route information for the route request message and broadcasts a routing control message specifying type information of an installed routing protocol to an adjacent node.

15. The node according to claim 14, wherein the routing control message is created by specifying the type information of the installed routing protocol in a type field.

16. The node according to claim 5, wherein the protocol selector transmits a routing control message, received from an adjacent node, to a routing processor having a predetermined routing protocol acquired from the routing control message installed therein.

17. A node in a network including a plurality of nodes, the node comprising:
a plurality of routing processors having different routing protocols installed therein, each of the routing processors having a routing table storing route information, the route information being set based upon a respective routing protocol; and
a protocol selector to acquire type information of the routing protocols of the routing processors and to transmit a routing control message, received from an adjacent node, to a predetermined routing processor having a routing protocol acquired from the routing control message installed therein;
a routing table manager to establish a system routing table based upon the route information stored in the routing tables of the routing processors and entries specifying type information of the routing tables; and
a wireless connector to search the system routing table for an entry including a destination address of a packet received via the network, and to rout the packet based upon route information of the searched entry.

18. A method of selecting a routing protocol in a network, the method comprising:
setting routing protocols according to application types at a node in the network, having different types of routing protocols installed therein;
acquiring type information of an application type from a route request message received from a client;
selecting type information of a routing protocol suitable for the acquired application type to set a route for the route request message; and
broadcasting a routing control message, including the type information of the suitable routing protocol, to an adjacent node.

19. A method of selecting a routing protocol, carried out by a node in a network, the method comprising:
establishing a route selection table including routing protocols to be selected according to application types;
acquiring type information of an application type from a route request message received from a client;
activating a routing protocol suitable for the acquired application type, to set a route for the route request message, and storing route information of the set route in a routing table;
broadcasting a routing control message, including type information of the suitable routing protocol, to an adjacent node;
establishing a system routing table based upon route information set according to the routing protocols and entries specifying type information of the routing protocols; and
searching the system routing table for a predetermined entry, including a destination address of a packet received via the network, and routing the packet based upon route information of the searched entry.

20. The method according to claim 19, wherein acquiring type information of an application type comprises extracting either a protocol field value or a value of a destination port address field of a header of the route request message.

21. The method according to claim 19, wherein establishing a system routing table comprises using a plurality of field values to be set in a destination port address field of the route request message, application type information for the field values, and type information of routing protocols set to primary, reusable and unusable based upon packet characteristics according to the application type.

22. The method according to claim 19, further comprising:
acquiring destination address information of the route request message and the type information of the routing protocol suitable for the application type;
determining whether or not a first entry identical with the destination address information and the type information of the suitable routing protocol exists in the system routing table;
using route information of the first entry as route information for the route request message in response to the first entry existing in the system routing table;
searching a second entry identical with the destination address information in response to the first entry not existing in the system routing table; and
using the type information of the routing protocol of the second entry as route information for the route request message in response to type information of a routing protocol of the second entry being reusable for the application type.

23. The method according to claim 19, wherein broadcasting a routing control message comprises specifying the type information of the routing protocol, by which the route is set, in a type field of the routing control message.

24. The method according to claim 19, wherein establishing a system routing table comprises: collecting added/updated route information to add/update the entries of the system routing table in response to route information of the routing tables being added/updated.

25. A method of selecting a routing protocol, carried out by a node in a network, the method comprising:
installing plural types of routing protocols;
acquiring type information a routing protocol from a routing control message received from an adjacent network;
activating the acquired routing protocol to set a route for the routing control message and storing route information of the set route in a routing table;
broadcasting a control message, including the type information of the routing protocol for the set route, to an adjacent node;
establishing a system routing table based upon route information, set according to the routing protocols and entries specifying type information of the routing protocols; and
searching the system routing table for a predetermined entry, including a destination address of a packet received via the network, and routing the packet based upon route information of the searched entry.
